(19) United States
(12) Patent Application Publication
(10) Pub. No.: US 2025/0203345 A1
(43) Pub. Date: Jun. 19, 2025

(54) OPTIMAL SPLITTER PRECODING

(71) Applicant: QUALCOMM Incorporated, San Diego, CA (US)

(72) Inventors: Aviv REGEV, Tel Aviv (IL); Assaf TOUBOUL, Netanya (IL); Gideon Shlomo KUTZ, Ramat Hasharon (IL); Ronen SHAKED, Kfar Saba (IL)

(21) Appl. No.: 18/543,436

(22) Filed: Dec. 18, 2023

(51) Int. Cl. H04W 8/22; H04W 72/21; H04W 72/232; H04W 72/51

(52) U.S. Cl. CPC H04W 8/22; H04W 72/21; H04W 72/232; H04W 72/51

(57) ABSTRACT

Certain aspects of the present disclosure provide techniques for optimal splitter precoding based on a user equipment (UE) demodulation capability. An example method performed by the UE includes receiving, from a network entity, a request for a demodulation capability of the UE, transmitting, to the network entity after receiving the request, a first message indicating the demodulation capability of the UE, receiving, from the network entity, a first downlink signal transmitted on a wireless channel using one or more groups of transmission streams comprising a first number of transmission streams, and demodulating the first downlink signal using a first demodulator corresponding to the first precoder. The first downlink signal may be precoded based on a first precoder and the first precoder may be based on the demodulation capability of the UE.

### BACKGROUND

### Field of the Disclosure

Aspects of the present disclosure relate to wireless communications, and more particularly, to techniques for optimal splitter precoding based on a user equipment (UE) demodulation capability.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network entity. The method includes transmitting, to a user equipment (UE), a request for a demodulation capability of the UE; receiving, from the UE after transmitting the request, a first message indicating the demodulation capability of the UE; applying a first precoder, selected based on the demodulation capability of the UE, to a first downlink signal for transmission to the UE; and transmitting the precoded first downlink signal to the UE on a wireless channel using one or more groups of transmission streams comprising a first number of transmission streams.

Another aspect provides a method for wireless communication by a user equipment (UE). The method includes receiving, from a network entity, a request for a demodulation capability of the UE; transmitting, to the network entity after receiving the request, a first message indicating the demodulation capability of the UE; receiving, from the network entity, a first downlink signal transmitted on a wireless channel using one or more groups of transmission streams comprising a first number of transmission streams, wherein: the first downlink signal is precoded based on a first precoder, and the first precoder is based on the demodulation capability of the UE; and demodulating the first downlink signal using a first demodulator corresponding to the first precoder.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a process flow including operations for communications in a network between a network entity and a user equipment.

FIG. 6 depicts a method for wireless communications.

FIG. 7 depicts a method for wireless communications.

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for optimal splitter precoding based on a user equipment (UE) demodulation capability.

For example, a main goal of next generation wireless networks is to increase a data rate associated with downlink communications. One manner of increasing the data rate is to increase an amount of downlink transmission streams that are used by a network entity, such as a base station, when transmitting downlink signals to the UE. For example, the number of downlink transmission streams is expected to grow from four transmission streams to eight transmission streams in next generation wireless networks, which may double the data rate of downlink communications for these next generation networks as compared to legacy wireless networks.

However, while network entities (e.g., base stations) may be capable of transmitting downlink signals using eight downlink transmission streams, there may be some scenarios in which certain UEs within the wireless network are not capable of simultaneously demodulating the eight downlink transmission streams, which may limit the amount of data that may be received by these UEs and may lead to inefficient use of time-frequency resources in the wireless network and poor user experience.

Accordingly, aspects of the present disclosure provide techniques for configuring and using a particular precoder, herein known as an optimal splitter precoder (OSP), to precode downlink signals to UEs that are unable to simultaneously demodulate a higher number of downlink transmission streams, such as eight or more transmission streams. When the network entity applies the OSP precoder to downlink signals and transmits the downlink signals on a wireless channel, the OSP precoder is configured to block-diagonalize or split the wireless channel into a plurality of separate sub-channels each comprising a different group of transmission streams. By block-diagonalizing or splitting the wireless channel into the plurality of separate sub-channels, the UE is able to perform separate, lower order demodulations on each different group of transmission streams included in the plurality of separate sub-channels, allowing for efficient use of the time-frequency resources in the wireless network and for improved user experience. The techniques described herein may also allow for configuration of precoders used for precoding downlink signals to be based on a demodulation capability of the UE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

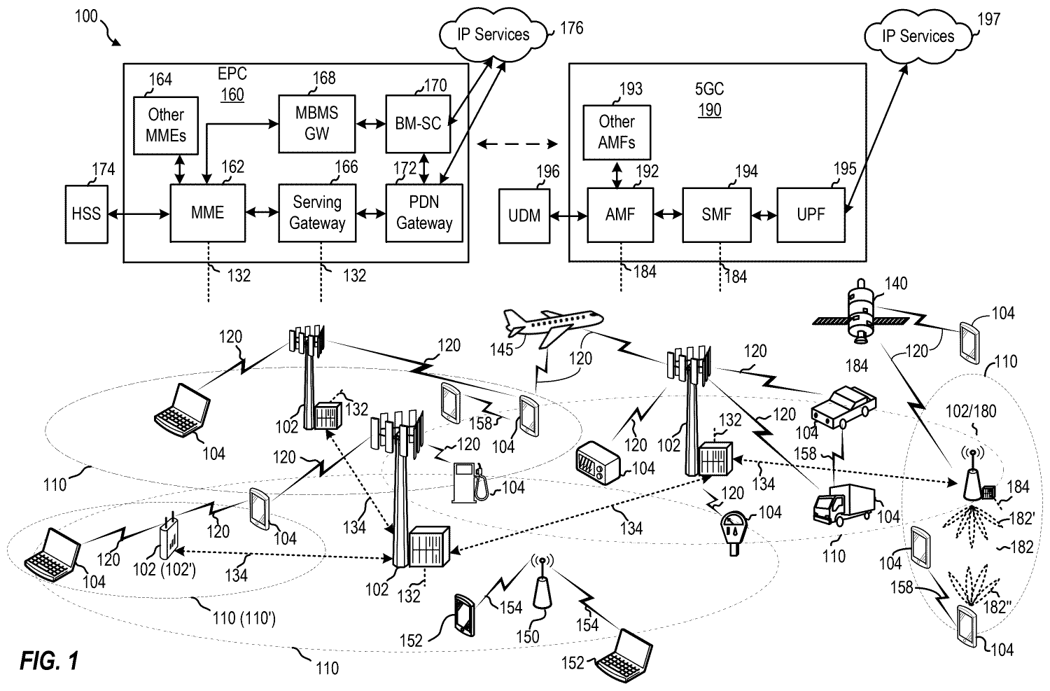

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

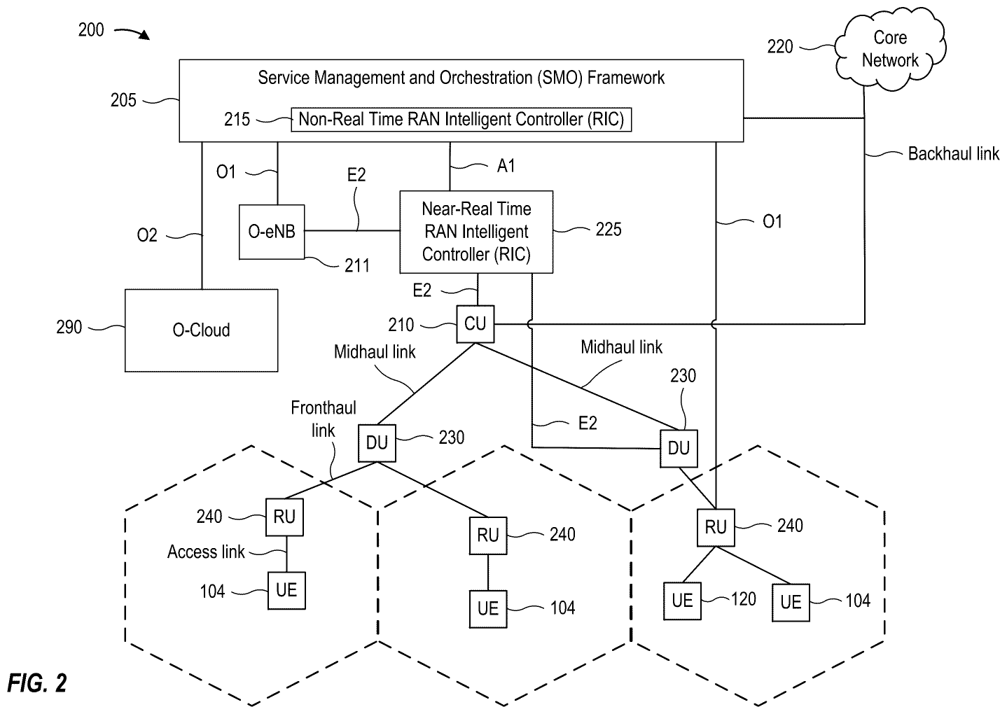

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

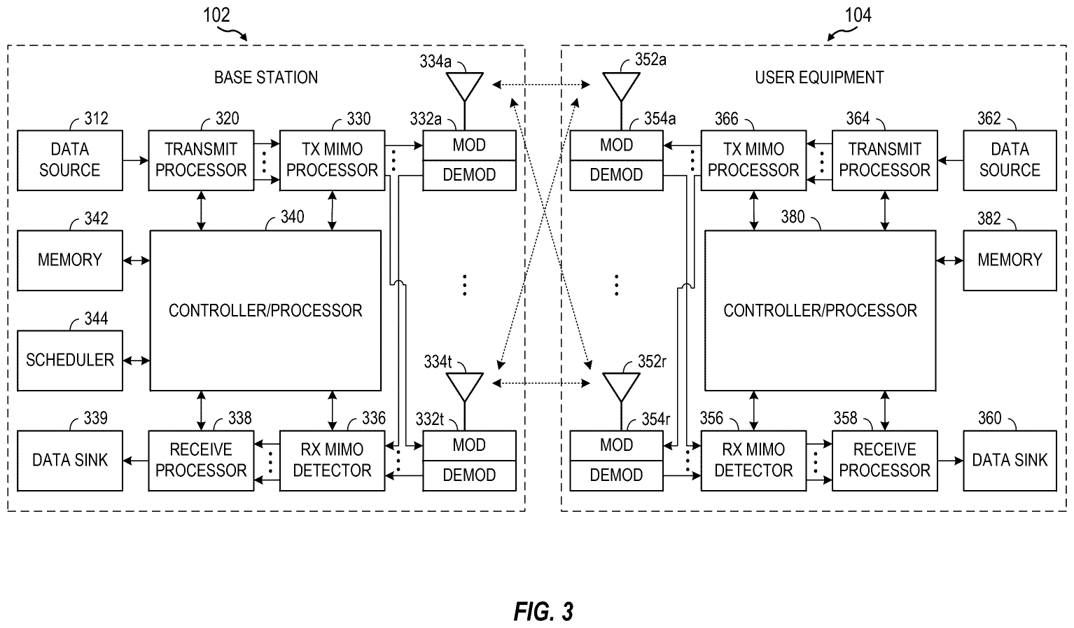

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

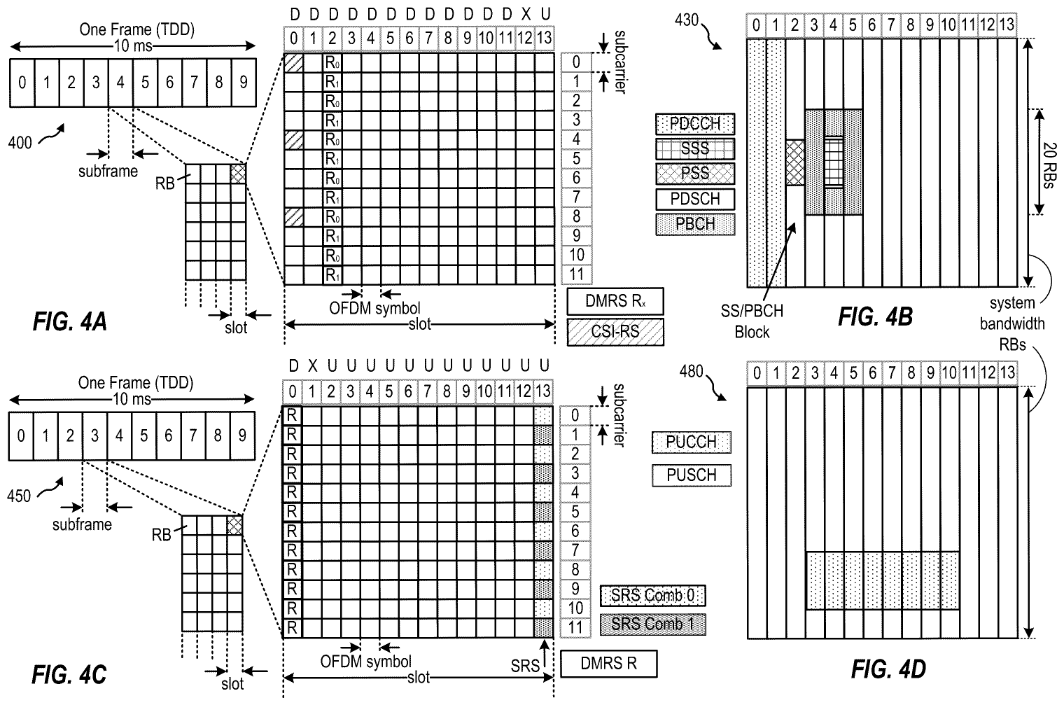

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Optimal Splitter Precoding

Increasing an attainable data rate by increasing the amount of transmitted data streams in downlink (DL) transmission is a main focus of next generation wireless networks, such a fifth generation (5G) advanced and sixth generation wireless networks. For example, in next generation systems, the DL transmission is expected to grow up to eight streams. This is due, in part, to the expectation that a number of antennas that a user equipment (UE) is equipped with will grow to eight from today's typical deployment in which UEs are equipped with only four antennas and thus are only capable of supporting four streams. As a result, increasing the number of streams to eight streams may double the data rate as compared to today's deployments.

Such large amount of transmitted data may, in some cases, be achievable due to advanced radio frequency (RF) and interference cancelation algorithms, a large amount of transmit (TX) antennas, and/or an optimal precoders, such as signular value decomposition (SVD). Additionally, next generation wireless networks are expected to have a higher density of gNodeBs (gNBs), which will yield higher SNR conditions and enable reception of such large amount of streams, simultaneously.

However, regardless the advanced tools or techniques that next generation gNBs will have, the DL reception at a UE is dependent on the UE's capability to demodulate the large amount of the transmitted streams (up to eight). Unfortunately, most of UEs are expected to have hardware that can demodulate only four streams rather than eight streams, due to incurred high complexity and power consumption. Thus, these UEs may not be capable of demodulating eight streams, even if they are equipped with eight receive (RX) antennas, thereby limiting the amount of data that may be received by these UEs and leading to inefficient use of time-frequency resources in a wireless network and poor user experience.

Accordingly, aspects of the present disclosure provide techniques for enabling a UE with a limited demodulation capability to demodulate a higher number of transmission streams. For example, these techniques may enable a UE, which is only capable of demodulating four transmission streams, to demodulate a higher number of transmission streams, such as eight transmission streams. In some cases, as will be described in more detail below, the techniques presented herein may involve using TX precoder, herein referred to as an optimal splitter precoder (OSP), that is configured to block diagonalize a precoded eight-TX-stream wireless channel over which a DL transmission is transmitted into two 4×4 sub-channels, ensuring that the eight TX streams of the DL transmission are observed at receiver device, such as a UE, as two decoupled groups of streams (e.g., 4 streams+4 streams). Using the OSP precoder to diagnoalize the precoded channel over which the DL transmission is transmitted may enable the receiver device to preform two different lower-order demodulations for each of the two groups of four streams and will be able to receive the DL transmission of eight streams. In some cases, the OSP precoder may assume “closed loop” system where a gNB may have channel state information (CSI) of a DL channel over which the DL transmission is to be transmitted (e.g. due to channel reciprocity).

Further, the techniques provided herein may allow the OSP precoder to be configured based on a demodulation capability of the UE. For example, in some cases, the UE may transmit a message to a network entity, such as a base station (e.g., gNB), indicating the demodulation capability of the UE. The demodulation capability of the UE may indicate, for example, a maximum number of transmission streams that the UE is capable of simultaneously demodulating. Accordingly, when the demodulation capability of the UE indicates that the maximum number of transmission streams that the UE is capable of simultaneously demodulating is greater than or equal to a number of transmission streams to be used for a DL transmission to the UE, the DL transmission may be precoded using a singular value decomposition (SVD) precoder.

Alternatively, when the demodulation capability of the UE indicates that the maximum number of transmission streams that the UE is capable of simultaneously demodulating is less than a number of transmission streams to be used for a DL transmission to the UE, the DL transmission may be precoded using the OSP precoder in order to block-diagonalize the wireless channel over which the DL transmission is to be transmitted into a plurality of separate sub-channels on which the UE is able to perform two separate lower-order demodulations. Additional details regarding the OSP precoder and techniques for configuring the OSP precoder based on the demodulation capability of the UE will be described in more detail below.

### Example OSP Precoder

As noted above, an OSP precoder may be used to block-diagonalize a wireless channel over which a DL transmission is to be transmitted. Block-diagonalizing the wireless channel may result in a plurality of separate sub-channels each comprising a different group of transmission streams that may be separately demodulated by a receiver deivce, such as a UE. For example, the OSP precoder may be used to split an 8×8 channel having eight transmission streams into two 4×4 channels each having only four transmissions streams and are separately demodulatable by the receiver device. While the following techniques relate to an 8×8 wireless channel being block-diagonalized into two separate 4×4 wireless channels, it should be understood that these techniques may also be used with wireless channels of any size (e.g., an N×N wireless channel, where N is any positive real number).

More specifically, an aim of the OSP precoder, p, is to change the wireless channel H such that the precoded wireless channel, Hp, is block-diagonalized as shown in Equation 1, below.

$$Hp = [ \begin{matrix}A & 0 \\ 0 & B\end{matrix} ] , \qquad ( 1 )$$

In Equation 1, A and B each represent 4×4 sub-channels on which data of a DL transmission will be transmitted and the zeros (0, 0) each represent a 4×4 matrix of zeros. While Equation 1 illustrates one matrix in which the precoded wireless channel is block diagonal, Equation 1 may also be rewritten to be block diagonal as shown in Equation 2.

$$Hp = [ \begin{matrix}0 & A \\ B & 0\end{matrix} ] , \qquad ( 2 )$$

To generate the OSP precoder, a transmitter device, such as a BS or gNB, may define and use a number of parameters in Equation 3, including as H₁, H₂, p₁, p₂, according to:

$$Hp = [ \begin{matrix}{H}_{1} \\ {H}_{2}\end{matrix} ] [ \begin{matrix}{p}_{1} & {p}_{2}\end{matrix} ] , \qquad ( 3 )$$

where H₁, H₂ are 4×8 matrixes that represent an “upper” and “lower” parts of the wireless channel, respectively, and p₁, p₂ are 8×4 matrixes that represent a left and a right part of the OSP precoder, respectively.

From matrix multiplication theory and Equations 1 and 3, the precoded block-diagonalized wireless channel may be represented as shown in Equation 4:

$$Hp = [ \begin{matrix}{H}_{1} {p}_{1} = A & {H}_{1} {p}_{2} = 0 \\ {H}_{2} {p}_{1} = 0 & {H}_{2} {p}_{2} = B\end{matrix} ] \qquad ( 4 )$$

In order to force H₂p₁ to be equal to zero matrix, p₁ should be part of the “null space” of H₂, leading to Equation 5, below. Similarly, in order to force H₁p₂ to be equal to zero matrix, p₂ should be part of the “null space” of H₁, leading to Equation 6, below.

$${H}_{1} {p}_{2} = 0 \to {p}_{2} = {\underbrace{( {{H}_{1}^{H} ( {H}_{1} {H}_{1}^{H} )}^{- 1} {H}_{1} - I )}}_{{M}_{1}} {\tilde{p}}_{2} = {M}_{1} {\tilde{p}}_{2} ∀ {\tilde{p}}_{2} \qquad ( 5 )$$

$${H}_{2} {p}_{1} = 0 \to {p}_{1} = {\underbrace{( {{H}_{2}^{H} ( {H}_{2} {H}_{2}^{H} )}^{- 1} {H}_{2} - I )}}_{{M}_{2}} {\tilde{p}}_{1} = {M}_{2} {\tilde{p}}_{1} ∀ {\tilde{p}}_{1} \qquad ( 6 )$$

In Equations 5 and 6, \tilde{p}₁ and \tilde{p}₂ may be any 8×4 fully ranked matrices and I is an identity matrix. At this point, the remaining things left to decide are the precoder matrices \tilde{p}₁ and \tilde{p}₂ and selection of a demodulator at the receiver device using a linear minimum mean square error (LMMSE) optimization problem, which will be explained below.

To demodulate the precoded downlink transmission, the demodulator, G, may be split into two different 4×4 demodulators according to Equation 7.

$$G = [ \begin{matrix}{G}_{0} & 0 \\ 0 & {G}_{2}\end{matrix} ] \qquad ( 7 )$$

The received precoded downlink signal after equalization may be represented as y_{eq}=GHpx+Gn, where x is an 8×1 vector that represents the streams over which data in the downlink transmission are transmitted and n is an 8×1 vector which represents additive noise at the receiver device.

The LMMSE optimization problem for selecting the precoder matrices \tilde{p}₁ and \tilde{p}₂ the demodulator G₁ and G₂ may then be applied according to Equation 8.

$$arg {min}_{{\tilde{p}}_{1} , {\tilde{p}}_{2}} {‖ [ \begin{matrix}{G}_{1} & 0 \\ 0 & {G}_{2}\end{matrix} ] \{ [ \begin{matrix}{H}_{1} {M}_{2} {\tilde{p}}_{1} & 0 \\ 0 & {H}_{2} {M}_{1} {\tilde{p}}_{2}\end{matrix} ] [ \begin{matrix}{x}_{u} \\ {x}_{l}\end{matrix} ] + [ \begin{matrix}{n}_{u} \\ {n}_{l}\end{matrix} ] \} - [ \begin{matrix}{x}_{u} \\ {x}_{l}\end{matrix} ] ‖}_{2}^{2} \qquad ( 8 )$$

In Equation 8, xᵤ is a first 4×1 vector representing a first (or upper) group of streams of the 8×1 vector x representing the streams over which the downlink transmission is received at the receiver device and xₗ is a second 4×1 vector representing a second (or lower) group of streams of the 8×1 vector x representing the streams over which the downlink transmission is received at the receiver device. Similarly, nu represents a first 4×1 vector of the 8×1 vector n of additive noise corresponding to the first (or upper) group of streams and nₗ represents a second 4×1 vector of the 8×1 vector n of additive noise corresponding to the second (or lower) group of streams.

Due to the full separation of the two groups of streams the LMMSE optimization problem may be separated into two optimization problems as shown in Equations 9 and 10, below. For example, Equation 9 may be used to determine a best precoder \tilde{p}₁ and a best demodulator G₁ for a given channel \tilde{H}₁.

$$arg {min}_{{\tilde{p}}_{1}} {‖ {G}_{1} \{ {\underbrace{{H}_{1} {M}_{2}}}_{{\tilde{H}}_{1}} {\tilde{p}}_{1} {x}_{u} + {n}_{u} \} - {x}_{u} ‖}_{2}^{2} = arg {min}_{{\tilde{p}}_{1}} {‖ {G}_{1} \{ {\tilde{H}}_{1} {\tilde{p}}_{1} {x}_{u} + {n}_{u} \} - {x}_{u} ‖}_{2}^{2} \qquad ( 9 )$$

Similarly, Equation 10 may be used to determine a best precoder \tilde{p}₂ and a best demodulator G₂ for a given channel \tilde{H}₂.

$$arg {min}_{{\tilde{p}}_{2}} {‖ {G}_{2} \{ {\underbrace{{H}_{2} {M}_{1}}}_{{\tilde{H}}_{2}} {\tilde{p}}_{2} {x}_{l} + {n}_{l} \} - {x}_{l} ‖}_{2}^{2} = arg {min}_{{\tilde{p}}_{2}} {‖ {G}_{2} \{ {\tilde{H}}_{2} {\tilde{p}}_{2} {x}_{l} + {n}_{l} \} - {x}_{l} ‖}_{2}^{2} \qquad ( 10 )$$

To solve the optimization problems shown in Equation 9 and Equation 10, the transmitter device may perform two singular value decompositions (SVDs) according to Equations 11 and 12, respectively, below.

$$[ \begin{matrix}{u}_{1} & {Σ}_{1} & {v}_{1}\end{matrix} ] = svd ( \tilde{{H}_{1}} ) = svd ( {H}_{1} {M}_{2} ) \qquad ( 11 )$$

$$[ \begin{matrix}{u}_{2} & {Σ}_{2} & {v}_{2}\end{matrix} ] = svd ( \tilde{{H}_{2}} ) = svd ( {H}_{2} {M}_{1} ) \qquad ( 12 )$$

The transmitter device may then determine \tilde{p}₁ according to

$${\tilde{p}}_{1} = \frac{{v}_{1}}{\sqrt{{N}_{ss}}}$$

and \tilde{p}₂ according to

$${\tilde{p}}_{2} = \frac{{v}_{2}}{\sqrt{{N}_{ss}}} ,$$

where Nₛₛ is the number of transmission streams to be used for a downlink signal to the receiver device. Additionally, the transmitter device may determine G₁ according to G₁=U₁^{H}Σ₁⁻¹ and G₂ according to G₂=U₂^{H}Σ₂⁻¹. Finally, to determine the precoder, p, the transmitter device may calculate M₁ and M₂ based on a reciprocity assumption (e.g., using Equations 5 and 6 based on H₁ and H₂) and may use M₁ and M₂ to determine p₁ and p₂ of the precoder p according to p₁=M₂ \tilde{p}₁ and \tilde{p}₂=M₁ \tilde{p}₂.

The transmitter device may then apply the OSP precoder, p, to a downlink signal for transmission to the receiver device on the wireless channel (e.g., H), which will block-diagonalize the wireless channel into a plurality of sub-channels (e.g., H₁ and H₂), each sub-channel comprising a different or separate group of transmission streams that are separately demodulateable by the receiver device. Thereafter, the transmitter device may transmit the precoded downlink signal to the receiver device on the wireless channel using the different groups of transmission streams. Additionally, the techniques described above may be used by the transmitter device and/or receiver device to determine a demodulator (e.g., G, including G₁ and G₂) that the receiver device may use to separately demodulate the different groups of transmission streams used to transmit the downlink transmission.

### Example Operations for Configuring a Precoder for Downlink Transmissions

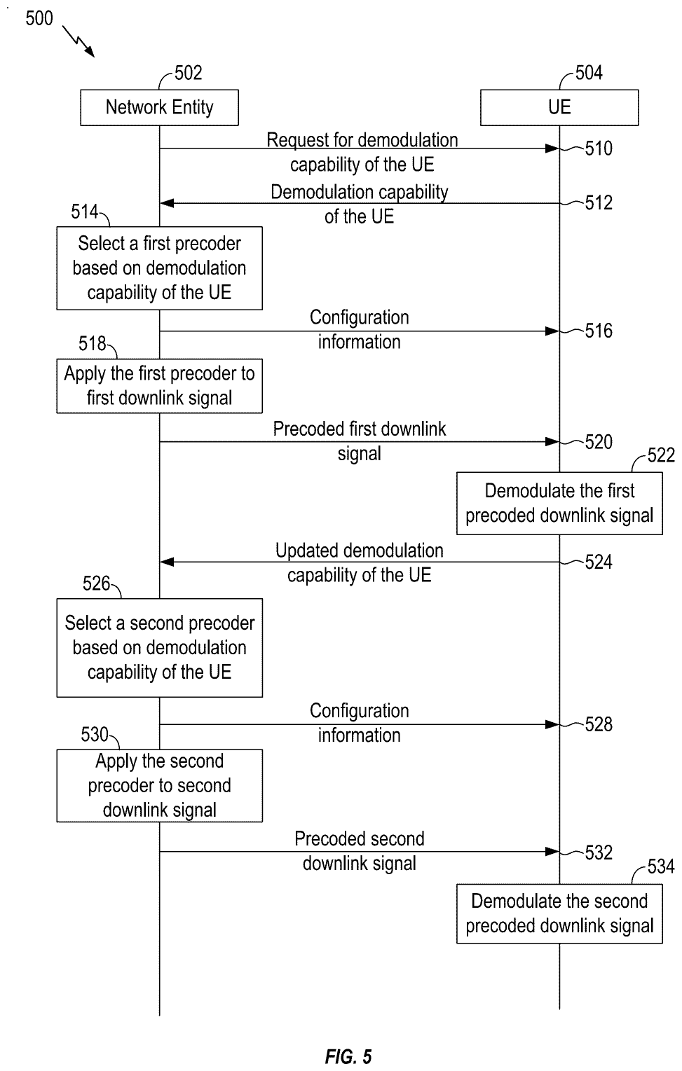

FIG. 5 depicts a process flow including operations 500 for communications in a network between a network entity 502 and a user equipment (UE) 504 for configuring a precoder, such as an OSP precoder or and SVD precoder, for downlink transmissions based on a demodulation capability of the UE 504. In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. However, in other aspects, UE 104 may be another type of wireless communications device and BS 102 may be another type of network entity or network node, such as those described herein.

As shown, operations 500 begin at 510 with the network entity 502 transmitting, to the UE 504, a request for a demodulation capability of the UE 504. In some cases, the request may be transmitted to the UE in a media access control-control element (MAC-CE) at the beginning of communication with the UE 504, such as during cell attachment. In some cases, the request may request the UE 504 indicate a maximum number of transmission streams that the UE 504 is capable of simultaneously demodulating.

At 512, the network entity 502 receives, from the UE 504 after transmitting the request, a first message indicating the demodulation capability of the UE 504. In some cases, the first message may be received from the UE 504 in a MAC-CE at the beginning of communication with the UE 504, such as during the cell attachment. In some cases, the demodulation capability of the UE 504 included in the first message may indicate a first maximum number of transmission streams that the UE 504 is capable of simultaneously demodulating.

At 514, the network entity 502 selects, based on the demodulation capability of the UE 504, a first precoder for precoding a first downlink signal for transmission to the UE 504 on a wireless channel using one or more groups of transmission streams comprising a first number of transmission streams.

In some cases, as indicated in the demodulation capability of the UE 504, the first maximum number of transmission streams that the UE 504 is capable of simultaneously demodulating is less than the first number of transmission streams that will be used by the network entity 502 to transmit the downlink signal on the wireless channel. In this case, the first precoder may comprise a precoder, such as the OSP precoder described above, that, when applied to the first downlink signal and the first downlink signal is transmitted on the wireless channel, is configured to block-diagonalize the wireless channel into a plurality of separate sub-channels or blocks. For example, when the first number of transmission streams that the network entity 502 will use to transmit the downlink signal comprises eight transmission streams, but the UE 504 only supports simultaneous demodulation of four transmission streams, the precoder may block-diagonalize the wireless channel into two separate sub-channels or blocks.

In some cases, each separate sub-channel of the plurality of separate sub-channels comprises a different group of transmission streams of the one or more groups of transmission streams. For example, in some cases, a first sub-channel or block may include a first group of transmission streams (e.g., transmission streams 1, 2, 3, and 4) and a second sub-channel or block may include a second group of transmission streams (e.g., transmission streams 5, 6, 7, and 8). In some cases, based on the precoder, each different group of transmission streams may be separately demodulatable by the UE 504, allowing the UE 504, for example, to demodulate the eight-stream downlink signal using two separate lower-order demodulations each comprising four streams.

In some cases, each different group of transmission streams may include a same number of transmission streams of the first number of transmission streams. For example, in some cases, assuming the downlink signal will be transmitted using eight transmission streams, the first group of transmission streams associated with the first sub-channel may include four transmission streams and the second group of transmission streams associated with the second sub-channel may include four transmission streams.

In some cases, each different group of transmission streams includes a different number of transmission streams of the first number of transmission streams. For example, in some cases, assuming the downlink signal will be transmitted using eight transmission streams, the first group of transmission streams associated with the first sub-channel may include five transmission streams and the second group of transmission streams associated with the second sub-channel may include three transmission streams.

In some cases, as indicated in the demodulation capability of the UE 504, the first maximum number of transmission streams that the UE 504 is capable of simultaneously demodulating may be greater than or equal to the first number of transmission streams that will be used by the network entity 502 to transmit the downlink signal on the wireless channel. In this case, the first precoder may comprise an SVD precoder as the UE 504 is capable of simultaneously demodulating all of the transmission streams that will be used to transmit the downlink signal and, thus, does not need the wireless channel to be block-diagonalized to allow the UE 504 to perform separate lower-order demodulations.

At 516, the network entity 502 transmits configuration information to the UE 504. In some cases, the configuration message may be transmitted by the network entity 502 to the UE 504 within downlink control information (DCI) on a physical downlink control channel (PDCCH).

In some cases, the configuration information may comprise an indication of the first precoder that will be used to precode the downlink signal. For example, when at 514 the network entity 502 selects the SVD precoder, the configuration information may include an indication that the SVD decoder will be used to transmit the downlink signal. Similarly, when at 514 the network entity 502 selects the OSP precoder, the configuration information may include an indication that the OSP decoder will be used to transmit the downlink signal.

In some cases, the configuration information may comprise an indication the first number of transmission streams that will be used to transmit the downlink signal to the UE 504. For example, if the downlink signal will be transmitted to the UE 504 using eight transmission streams, the configuration information may comprise an indication that the first number of transmission streams comprises eight transmission streams. In some cases, the eight transmission streams may be higher than the maximum number of transmission streams that the UE 504 is capable of simultaneously demodulated, as indicated in the demodulation capability of the UE 504; however, when the OSP decoder is used to precode the downlink signal, the UE 504 may be capable of decoding the downlink signal using separate lower-order demodulations, such as performing two separate four-stream demodulations.

In some cases, the configuration information may comprise an indication of how many groups of transmission streams are included in the one or more groups of transmission streams that will be used to transmit the downlink signal to the UE 504. For example, assuming the OSP precoder and eight transmission streams will be used to transmit the downlink signal, the configuration information may indicate that two separate groups of transmission streams, such as the first group of transmission streams and the second group of transmission streams described above. In some cases, the configuration information may also indicate how many transmission streams are included within each separate group of transmission streams. For example, in some cases, the configuration information may indicate that the first group of transmission streams includes four transmission streams and that the second group of transmission streams includes four transmission streams.

In some cases, the configuration information may comprise an indication of which transmission streams of the first number of transmission streams are included within each group of transmission streams of the one or more groups of transmission streams. For example, assuming the OSP precoder and eight transmission steams (e.g., transmission streams 1, 2, 3, 4, 5, 6, 7, and 8) will be used to transmit the downlink signal, the configuration information may comprise an indication that the first group of transmission streams includes transmission streams 1, 2, 3, and 4 and that the second group of transmission streams includes transmission streams 5, 6, 7, and 8.

At 518, the network entity 502 applies the first precoder, selected based on the demodulation capability of the UE, to the first downlink signal for transmission to the UE.

At 520, the network entity 502 transmits the precoded first downlink signal to the UE 504 on the wireless channel using the one or more groups of transmission streams comprising the first number of transmission streams.

At 522, the UE 504 demodulates the precoded first downlink signal using a first demodulator corresponding to the first precoder. In some cases, the UE 504 may determine the first demodulator (e.g., G) using techniques described above (e.g., related to Equations 1-12) based on channel estimation measurements used to estimate the wireless channel. In some cases, the first demodulator (e.g., G) may be determined based on an LMMSE-based demodulation taking into account the estimated wireless channel.

As noted above, in some cases, as indicated in the demodulation capability of the UE 504, the first maximum number of transmission streams that the UE 504 is capable of simultaneously demodulating is less than the first number of transmission streams on which the downlink signal is transmitted. In this case, the first precoder may comprise the OSP precoder that, when applied to the first downlink signal and the first downlink signal is transmitted on the wireless channel, is configured to block-diagonalize the wireless channel into a plurality of separate sub-channels, each separate sub-channel of the plurality of separate sub-channels comprising a different group of transmission streams.

In this case, demodulating the first downlink signal at 522 may comprise separately demodulating each different group of transmission streams. For example, assuming the first number of transmission streams is eight transmission streams and that the wireless channel has been block-diagonalized into a first sub-channel and a second sub-channel comprising the first group of transmission streams and the second group of transmission streams, respectively, the UE 504 may perform a first lower order (e.g., 4-stream) demodulation on the first group of transmission streams and a second lower order (e.g., 4-stream) demodulation on the second group of transmission streams.

Further, as noted above, in some cases, as indicated in the demodulation capability of the UE 504, the first maximum number of transmission streams that the UE 504 is capable of simultaneously demodulating is greater than or equal to the first number of transmission streams on which the downlink signal is transmitted. In this case, the first precoder may comprise the SVD precoder. In this case, because the UE 504 is capable of simultaneously demodulating a greater or equal number of transmission streams as the first number of transmission streams on which the downlink signal is transmitted, demodulating the downlink signal at 522 may comprise jointly demodulating the first number of transmission steams on which the downlink signal is transmitted. In other words, demodulating the downlink signal at 522 may comprise performing a single higher order (e.g., 8-stream) demodulation on the first number of transmission steams on which the downlink signal is transmitted.

In some cases, at 524, the UE 504 may transmit a second message to the network entity 502 indicating updated demodulation capability information of the UE 504. In some cases, the updated demodulation capability information of the UE 504 included in the second message may indicate a second maximum number of transmission streams that is different from the first maximum number of transmission indicated by the demodulation capability of the UE 504 included in the first message transmitted by the UE 504 at 512.

In some cases, the UE 504 may update its demodulation capability based on a change in operating conditions. In some cases, the change in operating conditions may include a change in a battery level. For example, if the first precoder used to precode the first downlink signal was an SVD precoder and the battery level of the UE 504 meets or drops below a threshold power level, the UE 504 may decide to reduce its demodulation capability to conserve battery power. For example, the UE 504 may indicate in the updated demodulation capability a reduced maximum number of transmission streams (e.g., the indicated second maximum number of transmission streams is lower than the first maximum number of transmission streams) so that the network entity 502 selects a new precoder, such as the OSP precoder, to precode downlink signals. For example, the OSP precoder may allow the UE 504 to perform the separate lower order demodulations, which may consume significantly less batter power as compared to a full demodulation capability used to decode downlink signals precoded with the SVD precoder

Alternatively, if the first precoder used to precode the first downlink signal was an OSP precoder and the battery level of the UE 504 rises above the threshold power level, the UE 504 may decide to increase its demodulation capability as it has sufficient battery power for full demodulation (e.g., which is power intensive). In this case, the UE 504 may indicate in the updated demodulation capability an increased maximum number of transmission streams (e.g., the indicated second maximum number of transmission streams is higher than the first maximum number of transmission streams) so that the network entity 502 selects a new precoder, such as the SVD precoder, to precode downlink signals transmitted to the UE 504.

In some cases, the change in operating conditions may include a change in transmission latency requirements associated with the UE. In some cases, the latency requirement may represent an amount of time that the UE is expected to receive, decode, and respond to a downlink signal from the network entity 502. For example, if the first precoder used to precode the first downlink signal was an SVD precoder and a transmission latency requirement associated with the UE 504 falls below a latency threshold (e.g., indicating the UE 504 has less time to receive, decode, and respond to downlink signals), the UE 504 may decide to reduce its demodulation capability, which may decrease its transmission latency while also conserving battery power.

For example, because the transmission latency requirement falls below the latency threshold, the UE 504 may indicate in the updated demodulation capability a reduced maximum number of transmission streams (e.g., the indicated second maximum number of transmission streams is lower than the first maximum number of transmission streams) so that the network entity 502 selects a new precoder, such as the OSP precoder (e.g., which may be associated with a higher transmission latency), to precode downlink signals. For example, the OSP precoder may allow the UE 504 to perform the separate lower order demodulations, which may decrease the transmission latency associated with the UE 504 since demodulating signals precoded based on an OSP precoder is less complex and takes less time as compared to demodulating signals precoded based on an SVD precoder.

Alternatively, if the first precoder used to precode the first downlink signal was an OSP precoder and the transmission latency requirement associated with the UE 504 increases above the latency threshold (e.g., indicating the UE 504 has more time to receive, decode, and respond to downlink signals), the UE 504 may decide to increase its demodulation capability as the UE 504 has additional time to receive, decode, and respond to downlink signals. For example, because the transmission latency requirement has increased above the latency threshold and because the UE 504 has more time to receive, decode, and respond to downlink signals, the UE 504 may indicate in the updated demodulation capability an increased maximum number of transmission streams (e.g., the indicated second maximum number of transmission streams is higher than the first maximum number of transmission streams) so that the network entity 502 selects a new precoder, such as the SVD precoder, to precode downlink signals transmitted to the UE 504. The SVD precoder may require the UE 504 to use a full demodulation capability, which is more complex and may take more time but may still satisfy the increased transmission latency requirement while also being more accurate.

In some cases, the change in the operating conditions may include a change in a temperature of the UE 504. For example, in some cases, when the first precoder used to precode the first downlink signal was an SVD precoder and the temperature of the UE 504 (or one or more components in the UE 504, such as a processor, modem, memory, etc.) rises above or meets a certain temperature threshold, the UE 504 may decide to reduce its demodulation capability to reduce the temperature of the UE 504. For example, the UE 504 may indicate in the updated demodulation capability a reduced maximum number of transmission streams (e.g., the indicated second maximum number of transmission streams is lower than the first maximum number of transmission streams) so that the network entity 502 selects a new precoder, such as the OSP precoder, to precode downlink signals. For example, the OSP precoder may allow the UE 504 to perform the separate lower order demodulations, which may allow the UE 504 to reduce the amount of processing resources or power used to demodulate these downlink signals and, thereby, reduce the temperature of the UE 504.

Alternatively, if the first precoder used to precode the first downlink signal was an OSP precoder and the temperature of the UE 504 (or one or more components in the UE 504, such as a processor, modem, memory, etc.) falls below the certain temperature threshold, the UE 504 may decide to increase its demodulation capability since the temperature of the UE 504 is below the temperature threshold and the UE 504 is able to handle an increase in processing resources or power associated with higher order demodulation. For example, in this case, the UE 504 may indicate in the updated demodulation capability an increased maximum number of transmission streams (e.g., the indicated second maximum number of transmission streams is higher than the first maximum number of transmission streams) so that the network entity 502 selects a new precoder, such as the SVD precoder, to precode downlink signals transmitted to the UE 504. While the SVD precoder may increase the processing resources or power associated with demodulating these downlink signals at the UE 504, this may be acceptable as the temperature of the UE 504 is below the temperature threshold.

As shown at 526, the network entity 502 selects, based on the updated demodulation capability of the UE 504, a second precoder for precoding a second downlink signal for transmission to the UE 504 on the wireless channel using one or more other groups of transmission streams comprising the first number of transmission streams. In some cases, the first precoder may be different from second precoder.

At 528, the network entity 502 transmits additional configuration information associated with the second precoder. The additional configuration information may be similar or indicate similar information as the configuration information described with respect to step 516, described above. For example, the additional configuration information include an indication of the second precoder, an indication the first number of transmission streams associated with the second precoder, an indication of how many groups of transmission streams are included in the one or more groups of transmission streams associated with the second precoder, and an indication of which transmission streams of the first number of transmission streams are included within each group of transmission streams of the one or more groups of transmission streams.

At 530, the network entity applies the second precoder, selected based on the updated demodulation capability of the UE, to a second downlink signal for transmission to the UE 504.

At 532, the network entity 502 transmits the precoded second downlink signal to the UE 504 on the wireless channel using the one or more groups of transmission streams comprising the first number of transmission streams.

At 534, the UE 504 demodulates the precoded second downlink signal using a second demodulator corresponding to the second precoder. In some cases, the second demodulator corresponding to the second precoder may be different from the first demodulator corresponding to the first precoder.

### Example Operations of a User Equipment

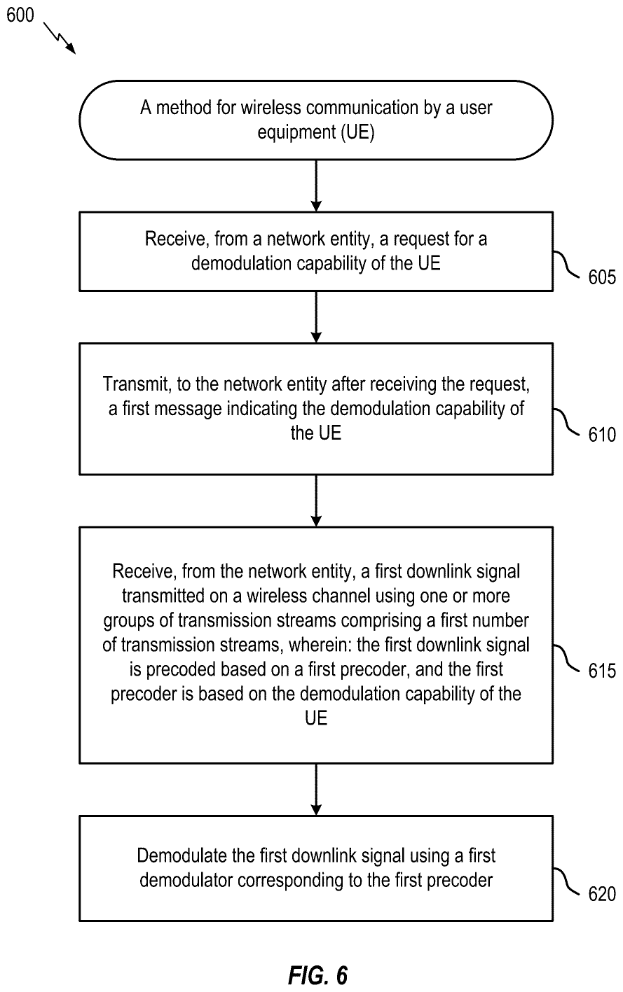

FIG. 6 shows an example of a method 600 of wireless communication by a user equipment (UE), such as a UE 104 of FIGS. 1 and 3.

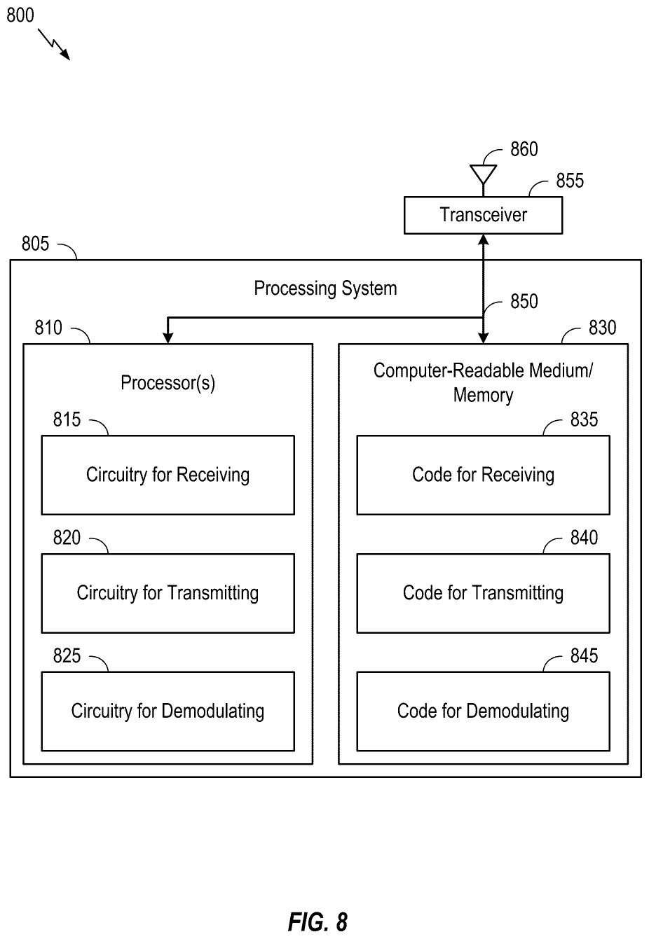

Method 600 begins at step 605 with receiving, from a network entity, a request for a demodulation capability of the UE. In some cases, the operations of this step refer to, or may be performed by, circuitry for receiving and/or code for receiving as described with reference to FIG. 8.

Method 600 then proceeds to step 610 with transmitting, to the network entity after receiving the request, a first message indicating the demodulation capability of the UE. In some cases, the operations of this step refer to, or may be performed by, circuitry for transmitting and/or code for transmitting as described with reference to FIG. 8.

Method 600 then proceeds to step 615 with receiving, from the network entity, a first downlink signal transmitted on a wireless channel using one or more groups of transmission streams comprising a first number of transmission streams, wherein: the first downlink signal is precoded based on a first precoder, and the first precoder is based on the demodulation capability of the UE. In some cases, the operations of this step refer to, or may be performed by, circuitry for receiving and/or code for receiving as described with reference to FIG. 8.

Method 600 then proceeds to step 620 with demodulating the first downlink signal using a first demodulator corresponding to the first precoder. In some cases, the operations of this step refer to, or may be performed by, circuitry for demodulating and/or code for demodulating as described with reference to FIG. 8.

In some aspects, the method 600 further includes receiving configuration information from the network entity, wherein the configuration information comprises: an indication of the first precoder, an indication the first number of transmission streams, an indication of how many groups of transmission streams are included in the one or more groups of transmission streams, and an indication of which transmission streams of the first number of transmission streams are included within each group of transmission streams of the one or more groups of transmission streams. In some cases, the operations of this step refer to, or may be performed by, circuitry for receiving and/or code for receiving as described with reference to FIG. 8.

In some aspects, receiving the configuration information from the network entity comprises receiving the configuration information from the network entity on a physical downlink control channel (PDCCH).

In some aspects, the demodulation capability of the UE indicates a first maximum number of transmission streams that the UE is capable of simultaneously demodulating.

In some aspects, the first maximum number of transmission streams that the UE is capable of simultaneously demodulating is less than the first number of transmission streams.

In some aspects, the first precoder comprises a precoder that, when applied to the first downlink signal and the first downlink signal is transmitted on the wireless channel, is configured to block-diagonalize the wireless channel into a plurality of separate sub-channels.

In some aspects, each separate sub-channel of the plurality of separate sub-channels comprises a different group of transmission streams of the one or more groups of transmission streams.

In some aspects, demodulating the first downlink signal comprises separately demodulating each different group of transmission streams.

In some aspects, each different group of transmission streams includes a same number of transmission streams of the first number of transmission streams.

In some aspects, each different group of transmission streams includes a different number of transmission streams of the first number of transmission streams.

In some aspects, the first maximum number of transmission streams that the UE is capable of simultaneously demodulating is greater than or equal to the first number of transmission streams; and the first precoder comprises a singular value decomposition (SVD) precoder.

In some aspects, demodulating the first downlink signal comprises jointly demodulating the first number of transmission steams.

In some aspects, the method 600 further includes transmitting a second message to the network entity indicating updated demodulation capability information of the UE. In some cases, the operations of this step refer to, or may be performed by, circuitry for transmitting and/or code for transmitting as described with reference to FIG. 8.

In some aspects, the updated demodulation capability information of the UE included in the second message indicates a second maximum number of transmission streams that is different from the first maximum number of transmission indicated by the demodulation capability of the UE included in the first message.

In some aspects, the method 600 further includes receiving, from the network entity, a second downlink signal transmitted on the wireless channel using one or more other groups of transmission streams comprising a first number of transmission streams, wherein the second downlink signal is precoded based on a second precoder, and the second precoder is based on the updated demodulation capability of the UE. In some cases, the operations of this step refer to, or may be performed by, circuitry for receiving and/or code for receiving as described with reference to FIG. 8.

In some aspects, the method 600 further includes demodulating the first downlink signal using a second demodulator corresponding to the second precoder. In some cases, the operations of this step refer to, or may be performed by, circuitry for demodulating and/or code for demodulating as described with reference to FIG. 8.

In some aspects, the first precoder is different from the second precoder; and the first demodulator is different from the second demodulator.

In some aspects, transmitting the second message to the network entity indicating the updated demodulation capability of the UE comprises transmitting the second message to the network entity on a physical uplink control channel (PUCCH).

In some aspects, at least one of: receiving the request from the network entity comprises receiving the request from the network entity in a media access control-control element (MAC-CE); or transmitting the first message to the network entity comprises transmitting the first message to the network entity in a MAC-CE.

In one aspect, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative steps are possible consistent with this disclosure.

### Example Operations of a Network Entity

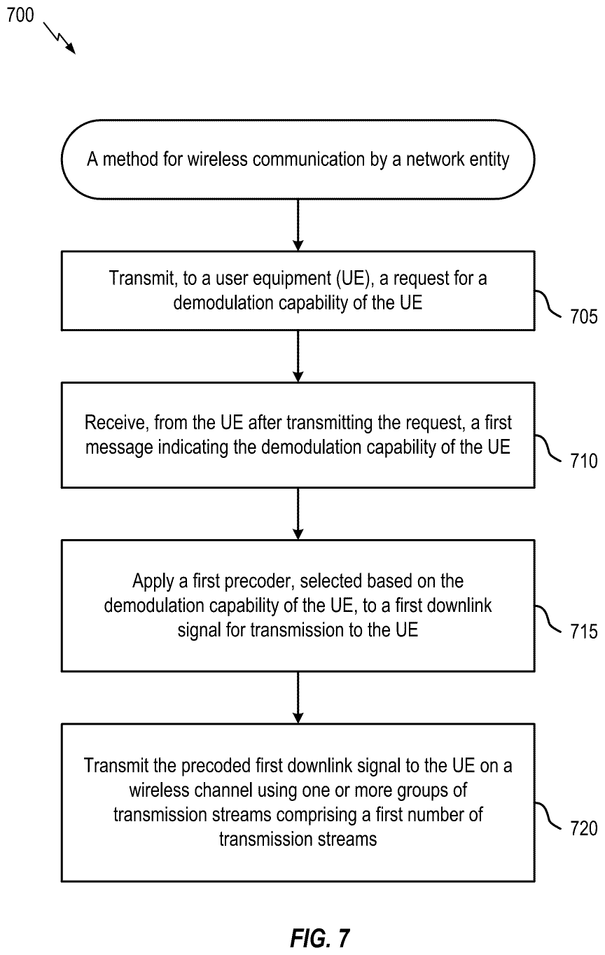

FIG. 7 shows an example of a method 700 of wireless communication by a network entity, such as a BS 102 of FIGS. 1 and 3, or a disaggregated base station as discussed with respect to FIG. 2.

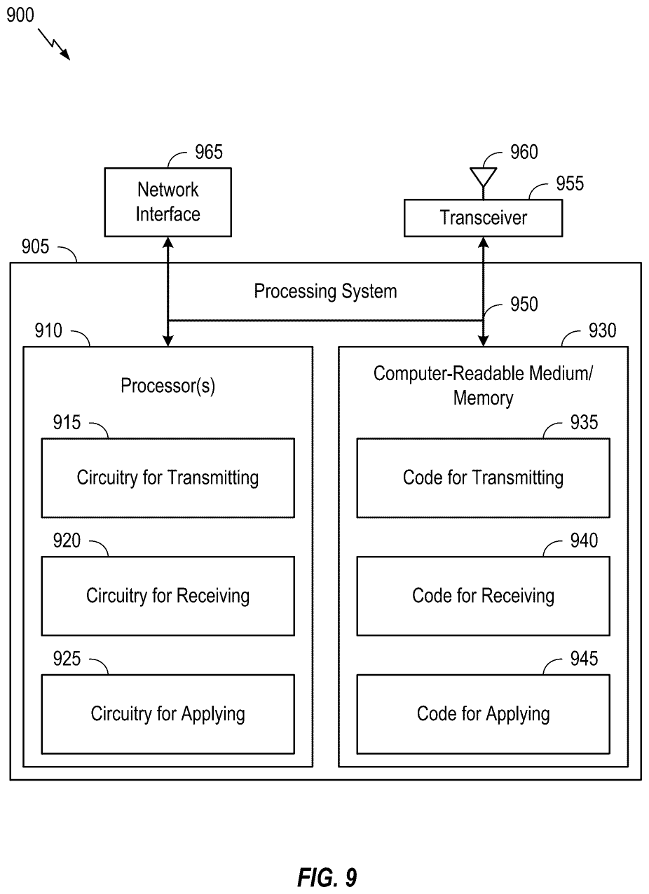

Method 700 begins at step 705 with transmitting, to a user equipment (UE), a request for a demodulation capability of the UE. In some cases, the operations of this step refer to, or may be performed by, circuitry for transmitting and/or code for transmitting as described with reference to FIG. 9.

Method 700 then proceeds to step 710 with receiving, from the UE after transmitting the request, a first message indicating the demodulation capability of the UE. In some cases, the operations of this step refer to, or may be performed by, circuitry for receiving and/or code for receiving as described with reference to FIG. 9.

Method 700 then proceeds to step 715 with applying a first precoder, selected based on the demodulation capability of the UE, to a first downlink signal for transmission to the UE. In some cases, the operations of this step refer to, or may be performed by, circuitry for applying and/or code for applying as described with reference to FIG. 9.

Method 700 then proceeds to step 720 with transmitting the precoded first downlink signal to the UE on a wireless channel using one or more groups of transmission streams comprising a first number of transmission streams. In some cases, the operations of this step refer to, or may be performed by, circuitry for transmitting and/or code for transmitting as described with reference to FIG. 9.

In some aspects, the method 700 further includes transmitting configuration information to the UE, wherein the configuration information comprises: an indication of the first precoder, an indication the first number of transmission streams, an indication of how many groups of transmission streams are included in the one or more groups of transmission streams, and an indication of which transmission streams of the first number of transmission streams are included within each group of transmission streams of the one or more groups of transmission streams. In some cases, the operations of this step refer to, or may be performed by, circuitry for transmitting and/or code for transmitting as described with reference to FIG. 9.

In some aspects, transmitting the configuration information to the UE comprises transmitting the configuration information to the UE on a physical downlink control channel (PDCCH).

In some aspects, the demodulation capability of the UE indicates a first maximum number of transmission streams that the UE is capable of simultaneously demodulating.

In some aspects, the first maximum number of transmission streams that the UE is capable of simultaneously demodulating is less than the first number of transmission streams.

In some aspects, the first precoder comprises a precoder that, when applied to the first downlink signal and the first downlink signal is transmitted on the wireless channel, is configured to block-diagonalize the wireless channel into a plurality of separate sub-channels.

In some aspects, each separate sub-channel of the plurality of separate sub-channels comprises a different group of transmission streams of the one or more groups of transmission streams.

In some aspects, each different group of transmission streams is separately demodulatable.

In some aspects, each different group of transmission streams includes a same number of transmission streams of the first number of transmission streams.

In some aspects, each different group of transmission streams includes a different number of transmission streams of the first number of transmission streams.

In some aspects, the first maximum number of transmission streams that the UE is capable of simultaneously demodulating is greater than or equal to the first number of transmission streams; and the first precoder comprises a singular value decomposition (SVD) precoder.

In some aspects, the method 700 further includes receiving a second message from the UE indicating updated demodulation capability information of the UE. In some cases, the operations of this step refer to, or may be performed by, circuitry for receiving and/or code for receiving as described with reference to FIG. 9.

In some aspects, the updated demodulation capability information of the UE included in the second message indicates a second maximum number of transmission streams that is different from the first maximum number of transmission indicated by the demodulation capability of the UE included in the first message.

In some aspects, the method 700 further includes applying a second precoder, selected based on the updated demodulation capability of the UE, to a second downlink signal for transmission to the UE. In some cases, the operations of this step refer to, or may be performed by, circuitry for applying and/or code for applying as described with reference to FIG. 9.

In some aspects, the method 700 further includes transmitting the precoded second downlink signal to the UE on the wireless channel using one or more other groups of transmission streams comprising the first number of transmission streams. In some cases, the operations of this step refer to, or may be performed by, circuitry for transmitting and/or code for transmitting as described with reference to FIG. 9.

In some aspects, the first precoder is different from the second precoder.

In some aspects, receiving the second message from the UE indicating the updated demodulation capability of the UE comprises receiving the second message from the UE on a physical uplink control channel (PUCCH).

In some aspects, at least one of: transmitting the request to the UE comprises transmitting the request to the UE in a media access control-control element (MAC-CE); or receiving the first message from the UE comprises receiving the first message from the UE in a MAC-CE.

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Communications Device(s)

FIG. 8 depicts aspects of an example communications device 800. In some aspects, communications device 800 is a user equipment, such as UE 104 described above with respect to FIGS. 1 and 3.

The communications device 800 includes a processing system 805 coupled to the transceiver 855 (e.g., a transmitter and/or a receiver). The transceiver 855 is configured to transmit and receive signals for the communications device 800 via the antenna 860, such as the various signals as described herein. The processing system 805 may be configured to perform processing functions for the communications device 800, including processing signals received and/or to be transmitted by the communications device 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 830 via a bus 850. In certain aspects, the computer-readable medium/memory 830 is configured to store instructions (e.g., computer-executable code) that when executed by the one or more processors 810, cause the one or more processors 810 to perform the method 600 described with respect to FIG. 6, or any aspect related to it. Note that reference to a processor performing a function of communications device 800 may include one or more processors 810 performing that function of communications device 800.

In the depicted example, computer-readable medium/memory 830 stores code (e.g., executable instructions), such as code for receiving 835, code for transmitting 840, and code for demodulating 845. Processing of the code for receiving 835, code for transmitting 840, and code for demodulating 845 may cause the communications device 800 to perform the method 600 described with respect to FIG. 6, or any aspect related to it.

The one or more processors 810 include circuitry configured to implement (e.g., execute) the code stored in the computer-readable medium/memory 830, including circuitry such as circuitry for receiving 815, circuitry for transmitting 820, and circuitry for demodulating 825. Processing with circuitry for receiving 815, circuitry for transmitting 820, and circuitry for demodulating 825 may cause the communications device 800 to perform the method 600 described with respect to FIG. 6, or any aspect related to it.

Various components of the communications device 800 may provide means for performing the method 600 described with respect to FIG. 6, or any aspect related to it. For example, means for transmitting, sending or outputting for transmission may include transceivers 354 and/or antenna(s) 352 of the UE 104 illustrated in FIG. 3 and/or the transceiver 855 and the antenna 860 of the communications device 800 in FIG. 8. Means for receiving or obtaining may include transceivers 354 and/or antenna(s) 352 of the UE 104 illustrated in FIG. 3 and/or the transceiver 855 and the antenna 860 of the communications device 800 in FIG. 8.

FIG. 9 depicts aspects of an example communications device 900. In some aspects, communications device 900 is a network entity, such as BS 102 of FIGS. 1 and 3, or a disaggregated base station as discussed with respect to FIG. 2.

The communications device 900 includes a processing system 905 coupled to the transceiver 955 (e.g., a transmitter and/or a receiver) and/or a network interface 965. The transceiver 955 is configured to transmit and receive signals for the communications device 900 via the antenna 960, such as the various signals as described herein. The network interface 965 is configured to obtain and send signals for the communications device 900 via communication link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 930 via a bus 950. In certain aspects, the computer-readable medium/memory 930 is configured to store instructions (e.g., computer-executable code) that when executed by the one or more processors 910, cause the one or more processors 910 to perform the method 700 described with respect to FIG. 7, or any aspect related to it. Note that reference to a processor of communications device 900 performing a function may include one or more processors 910 of communications device 900 performing that function.

In the depicted example, the computer-readable medium/memory 930 stores code (e.g., executable instructions), such as code for transmitting 935, code for receiving 940, and code for applying 945. Processing of the code for transmitting 935, code for receiving 940, and code for applying 945 may cause the communications device 900 to perform the method 700 described with respect to FIG. 7, or any aspect related to it.

The one or more processors 910 include circuitry configured to implement (e.g., execute) the code stored in the computer-readable medium/memory 930, including circuitry such as circuitry for transmitting 915, circuitry for receiving 920, and circuitry for applying 925. Processing with circuitry for transmitting 915, circuitry for receiving 920, and circuitry for applying 925 may cause the communications device 900 to perform the method 700 described with respect to FIG. 7, or any aspect related to it.

Various components of the communications device 900 may provide means for performing the method 700 described with respect to FIG. 7, or any aspect related to it. Means for transmitting, sending or outputting for transmission may include transceivers 332 and/or antenna(s) 334 of the BS 102 illustrated in FIG. 3 and/or the transceiver 955 and the antenna 960 of the communications device 900 in FIG. 9. Means for receiving or obtaining may include transceivers 332 and/or antenna(s) 334 of the BS 102 illustrated in FIG. 3 and/or the transceiver 955 and the antenna 960 of the communications device 900 in FIG. 9.

### EXAMPLE CLAUSES

Implementation examples are described in the following numbered clauses:

Clause 1: A method for wireless communication by a network entity, comprising: transmitting, to a user equipment (UE), a request for a demodulation capability of the UE; receiving, from the UE after transmitting the request, a first message indicating the demodulation capability of the UE; applying a first precoder, selected based on the demodulation capability of the UE, to a first downlink signal for transmission to the UE; and transmitting the precoded first downlink signal to the UE on a wireless channel using one or more groups of transmission streams comprising a first number of transmission streams.

Clause 2: The method of Clause 1, further comprising transmitting configuration information to the UE, wherein the configuration information comprises: an indication of the first precoder, an indication the first number of transmission streams, an indication of how many groups of transmission streams are included in the one or more groups of transmission streams, and an indication of which transmission streams of the first number of transmission streams are included within each group of transmission streams of the one or more groups of transmission streams.

Clause 3: The method of Clause 2, wherein transmitting the configuration information to the UE comprises transmitting the configuration information to the UE on a physical downlink control channel (PDCCH).

Clause 4: The method of any one of Clauses 1-3, wherein the demodulation capability of the UE indicates a first maximum number of transmission streams that the UE is capable of simultaneously demodulating.

Clause 5: The method of Clause 4, wherein the first maximum number of transmission streams that the UE is capable of simultaneously demodulating is less than the first number of transmission streams.

Clause 6: The method of Clause 5, wherein the first precoder comprises a precoder that, when applied to the first downlink signal and the first downlink signal is transmitted on the wireless channel, is configured to block-diagonalize the wireless channel into a plurality of separate sub-channels.

Clause 7: The method of Clause 6, wherein each separate sub-channel of the plurality of separate sub-channels comprises a different group of transmission streams of the one or more groups of transmission streams.

Clause 8: The method of Clause 7, wherein each different group of transmission streams is separately demodulatable.

Clause 9: The method of any one of Clauses 7-8, wherein each different group of transmission streams includes a same number of transmission streams of the first number of transmission streams.

Clause 10: The method of any one of Clauses 7-8, wherein each different group of transmission streams includes a different number of transmission streams of the first number of transmission streams.

Clause 11: The method of Clause 4, wherein: the first maximum number of transmission streams that the UE is capable of simultaneously demodulating is greater than or equal to the first number of transmission streams; and the first precoder comprises a singular value decomposition (SVD) precoder.

Clause 12: The method of any one of Clauses 4-11, further comprising receiving a second message from the UE indicating updated demodulation capability information of the UE.

Clause 13: The method of Clause 12, wherein the updated demodulation capability information of the UE included in the second message indicates a second maximum number of transmission streams that is different from the first maximum number of transmission indicated by the demodulation capability of the UE included in the first message.

Clause 14: The method of Clause 13, further comprising: applying a second precoder, selected based on the updated demodulation capability of the UE, to a second downlink signal for transmission to the UE; and transmitting the precoded second downlink signal to the UE on the wireless channel using one or more other groups of transmission streams comprising the first number of transmission streams.

Clause 15: The method of Clause 14, wherein the first precoder is different from the second precoder.

Clause 16: The method of any one of Clauses 12-15, wherein receiving the second message from the UE indicating the updated demodulation capability of the UE comprises receiving the second message from the UE on a physical uplink control channel (PUCCH).

Clause 17: The method of any one of Clauses 1-16, wherein at least one of: transmitting the request to the UE comprises transmitting the request to the UE in a media access control-control element (MAC-CE); or receiving the first message from the UE comprises receiving the first message from the UE in a MAC-CE.

Clause 18: A method for wireless communication by a user equipment (UE), comprising: receiving, from a network entity, a request for a demodulation capability of the UE; transmitting, to the network entity after receiving the request, a first message indicating the demodulation capability of the UE; receiving, from the network entity, a first downlink signal transmitted on a wireless channel using one or more groups of transmission streams comprising a first number of transmission streams, wherein: the first downlink signal is precoded based on a first precoder, and the first precoder is based on the demodulation capability of the UE; and demodulating the first downlink signal using a first demodulator corresponding to the first precoder.

Clause 19: The method of Clause 18, further comprising receiving configuration information from the network entity, wherein the configuration information comprises: an indication of the first precoder, an indication the first number of transmission streams, an indication of how many groups of transmission streams are included in the one or more groups of transmission streams, and an indication of which transmission streams of the first number of transmission streams are included within each group of transmission streams of the one or more groups of transmission streams.

Clause 20: The method of Clause 19, wherein receiving the configuration information from the network entity comprises receiving the configuration information from the network entity on a physical downlink control channel (PDCCH).

Clause 21: The method of any one of Clauses 18-20, wherein the demodulation capability of the UE indicates a first maximum number of transmission streams that the UE is capable of simultaneously demodulating.

Clause 22: The method of Clause 21, wherein the first maximum number of transmission streams that the UE is capable of simultaneously demodulating is less than the first number of transmission streams.

Clause 23: The method of Clause 22, wherein the first precoder comprises a precoder that, when applied to the first downlink signal and the first downlink signal is transmitted on the wireless channel, is configured to block-diagonalize the wireless channel into a plurality of separate sub-channels.

Clause 24: The method of Clause 23, wherein each separate sub-channel of the plurality of separate sub-channels comprises a different group of transmission streams of the one or more groups of transmission streams.

Clause 25: The method of Clause 24, wherein demodulating the first downlink signal comprises separately demodulating each different group of transmission streams.

Clause 26: The method of any one of Clauses 24-25, wherein each different group of transmission streams includes a same number of transmission streams of the first number of transmission streams.

Clause 27: The method of any one of Clauses 24-25, wherein each different group of transmission streams includes a different number of transmission streams of the first number of transmission streams.

Clause 28: The method of Clause 21, wherein: the first maximum number of transmission streams that the UE is capable of simultaneously demodulating is greater than or equal to the first number of transmission streams; and the first precoder comprises a singular value decomposition (SVD) precoder.

Clause 29: The method of Clause 28, wherein demodulating the first downlink signal comprises jointly demodulating the first number of transmission steams.

Clause 30: The method of any one of Clauses 21-29, further comprising transmitting a second message to the network entity indicating updated demodulation capability information of the UE.

Clause 31: The method of Clause 30, wherein the updated demodulation capability information of the UE included in the second message indicates a second maximum number of transmission streams that is different from the first maximum number of transmission indicated by the demodulation capability of the UE included in the first message.

Clause 32: The method of Clause 31, further comprising: receiving, from the network entity, a second downlink signal transmitted on the wireless channel using one or more other groups of transmission streams comprising a first number of transmission streams, wherein the second downlink signal is precoded based on a second precoder, and the second precoder is based on the updated demodulation capability of the UE; and demodulating the first downlink signal using a second demodulator corresponding to the second precoder.

Clause 33: The method of Clause 32, wherein: the first precoder is different from the second precoder; and the first demodulator is different from the second demodulator.

Clause 34: The method of any one of Clauses 30-33, wherein transmitting the second message to the network entity indicating the updated demodulation capability of the UE comprises transmitting the second message to the network entity on a physical uplink control channel (PUCCH).

Clause 35: The method of any one of Clauses 18-34, wherein at least one of: receiving the request from the network entity comprises receiving the request from the network entity in a media access control-control element (MAC-CE); or transmitting the first message to the network entity comprises transmitting the first message to the network entity in a MAC-CE.

Clause 36: An apparatus, comprising: at least one memory comprising executable instructions; and at least one processor configured to execute the executable instructions and cause the apparatus to perform a method in accordance with any one of Clauses 1-35.

Clause 37: An apparatus, comprising means for performing a method in accordance with any one of Clauses 1-35.

Clause 38: A non-transitory computer-readable medium comprising executable instructions that, when executed by at least one processor of an apparatus, cause the apparatus to perform a method in accordance with any one of Clauses 1-35.

Clause 39: A computer program product embodied on a computer-readable storage medium comprising code for performing a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication by a network entity, comprising:
one or more processors individually or collectively configured to execute instructions on one or more memories and to cause the network entity to:
transmit, to a user equipment (UE), a request for a demodulation capability of the UE;
receive, from the UE after transmitting the request, a first message indicating the demodulation capability of the UE;
apply a first precoder, selected based on the demodulation capability of the UE, to a first downlink signal for transmission to the UE; and
transmit the precoded first downlink signal to the UE on a wireless channel using one or more groups of transmission streams comprising a first number of transmission streams.

2. The apparatus of claim 1, wherein the one or more processors are further configured to cause the network entity to transmit configuration information to the UE, wherein the configuration information comprises:
an indication of the first precoder;
an indication the first number of transmission streams;
an indication of how many groups of transmission streams are included in the one or more groups of transmission streams; and
an indication of which transmission streams of the first number of transmission streams are included within each group of transmission streams of the one or more groups of transmission streams.

3. The apparatus of claim 2, wherein the one or more processors are configured to cause the network entity to transmit the configuration information to the UE on a physical downlink control channel (PDCCH).

4. The apparatus of claim 1, wherein the demodulation capability of the UE indicates a first maximum number of transmission streams that the UE is capable of simultaneously demodulating.

5. The apparatus of claim 4, wherein the first maximum number of transmission streams that the UE is capable of simultaneously demodulating is less than the first number of transmission streams.

6. The apparatus of claim 5, wherein the first precoder comprises a precoder that, when applied to the first downlink signal and the first downlink signal is transmitted on the wireless channel, is configured to block-diagonalize the wireless channel into a plurality of separate sub-channels.

7. The apparatus of claim 6, wherein each separate sub-channel of the plurality of separate sub-channels comprises a different group of transmission streams of the one or more groups of transmission streams.

8. The apparatus of claim 7, wherein each different group of transmission streams is separately demodulatable.

9. The apparatus of claim 7, wherein each different group of transmission streams includes a same number of transmission streams of the first number of transmission streams.

10. The apparatus of claim 7, wherein each different group of transmission streams includes a different number of transmission streams of the first number of transmission streams.

11. The apparatus of claim 4, wherein:
the first maximum number of transmission streams that the UE is capable of simultaneously demodulating is greater than or equal to the first number of transmission streams; and
the first precoder comprises a singular value decomposition (SVD) precoder.

12. The apparatus of claim 4, wherein the one or more processors are further configured to cause the network entity to receive, on a physical uplink control channel (PUCCH), a second message from the UE indicating updated demodulation capability information of the UE, wherein the updated demodulation capability information of the UE included in the second message indicates a second maximum number of transmission streams that is different from the first maximum number of transmission indicated by the demodulation capability of the UE included in the first message.

13. The apparatus of claim 12, wherein the one or more processors are further configured to cause the network entity to:
apply a second precoder, selected based on the updated demodulation capability of the UE, to a second downlink signal for transmission to the UE; and
transmit the precoded second downlink signal to the UE on the wireless channel using one or more other groups of transmission streams comprising the first number of transmission streams, wherein the first precoder is different from the second precoder.

14. The apparatus of claim 1, wherein at least one of:
the one or more processors are configured to cause the network entity to transmit the request to the UE in a media access control-control element (MAC-CE); or
the one or more processors are configured to cause the network entity to receive the first message from the UE in a MAC-CE.

15. An apparatus for wireless communication by a user equipment (UE), comprising:
one or more processors individually or collectively configured to execute instructions on one or more memories and to cause the UE to:
receive, from a network entity, a request for a demodulation capability of the UE;
transmit, to the network entity after receiving the request, a first message indicating the demodulation capability of the UE;
receive, from the network entity, a first downlink signal transmitted on a wireless channel using one or more groups of transmission streams comprising a first number of transmission streams, wherein:
the first downlink signal is precoded based on a first precoder; and
the first precoder is based on the demodulation capability of the UE; and
demodulate the first downlink signal using a first demodulator corresponding to the first precoder.

16. The apparatus of claim 15, wherein the one or more processors are further configured to cause the UE to receive configuration information from the network entity, wherein the configuration information comprises:
an indication of the first precoder;
an indication the first number of transmission streams;
an indication of how many groups of transmission streams are included in the one or more groups of transmission streams; and
an indication of which transmission streams of the first number of transmission streams are included within each group of transmission streams of the one or more groups of transmission streams.

17. The apparatus of claim 16, wherein the one or more processors are further configured to cause the UE to receive the configuration information from the network entity on a physical downlink control channel (PDCCH).

18. The apparatus of claim 15, wherein the demodulation capability of the UE indicates a first maximum number of transmission streams that the UE is capable of simultaneously demodulating.

19. The apparatus of claim 18, wherein the first maximum number of transmission streams that the UE is capable of simultaneously demodulating is less than the first number of transmission streams.

20. The apparatus of claim 19, wherein the first precoder comprises a precoder that, when applied to the first downlink signal and the first downlink signal is transmitted on the wireless channel, is configured to block-diagonalize the wireless channel into a plurality of separate sub-channels.

21. The apparatus of claim 20, wherein each separate sub-channel of the plurality of separate sub-channels comprises a different group of transmission streams of the one or more groups of transmission streams.

22. The apparatus of claim 21, wherein, in order to demodulate the first downlink signal, the one or more processors are configured to cause the UE to separately demodulate each different group of transmission streams.

23. The apparatus of claim 21, wherein each different group of transmission streams includes a same number of transmission streams of the first number of transmission streams.

24. The apparatus of claim 20, wherein each different group of transmission streams includes a different number of transmission streams of the first number of transmission streams.

25. The apparatus of claim 18, wherein:
the first maximum number of transmission streams that the UE is capable of simultaneously demodulating is greater than or equal to the first number of transmission streams; and
the first precoder comprises a singular value decomposition (SVD) precoder; and
in order to demodulate the first downlink signal, the one or more processors are configured to cause the UE to jointly demodulate the first number of transmission steams.

26. The apparatus of claim 18, wherein the one or more processors are further configured to cause the UE to transmit, on a physical uplink control channel (PUCCH), a second message to the network entity indicating updated demodulation capability information of the UE, wherein the updated demodulation capability information of the UE included in the second message indicates a second maximum number of transmission streams that is different from the first maximum number of transmission indicated by the demodulation capability of the UE included in the first message.

27. The apparatus of claim 26, wherein:
the one or more processors are further configured to cause the UE to:
receive, from the network entity, a second downlink signal transmitted on the wireless channel using one or more other groups of transmission streams comprising a first number of transmission streams; and
demodulate the second downlink signal using a second demodulator corresponding to a second precoder;
the second downlink signal is precoded based on the second precoder;
the second precoder is based on the updated demodulation capability of the UE;
the first precoder is different from the second precoder; and
the first demodulator is different from the second demodulator.

28. The apparatus of claim 15, wherein at least one of:
the one or more processors are configured to cause the UE to receive the request from the network entity in a media access control-control element (MAC-CE); or
the one or more processors are configured to cause the UE to transmit the first message to the network entity in a MAC-CE.

29. A method for wireless communication by a network entity, comprising:
transmitting, to a user equipment (UE), a request for a demodulation capability of the UE;
receiving, from the UE after transmitting the request, a first message indicating the demodulation capability of the UE;
applying a first precoder, selected based on the demodulation capability of the UE, to a first downlink signal for transmission to the UE; and
transmitting the precoded first downlink signal to the UE on a wireless channel using one or more groups of transmission streams comprising a first number of transmission streams.

30. A method for wireless communication by a user equipment (UE), comprising:
receiving, from a network entity, a request for a demodulation capability of the UE;
transmitting, to the network entity after receiving the request, a first message indicating the demodulation capability of the UE;
receiving, from the network entity, a first downlink signal transmitted on a wireless channel using one or more groups of transmission streams comprising a first number of transmission streams, wherein:
the first downlink signal is precoded based on a first precoder; and
the first precoder is based on the demodulation capability of the UE; and
demodulating the first downlink signal using a first demodulator corresponding to the first precoder.
